(19) United States
(12) Patent Application Publication
(10) Pub. No.: US 2004/0145146 A1
(43) Pub. Date: Jul. 29, 2004

(54) Automobile footrest latch structure and its latch member thereof

(75) Inventor: Ming Fang Wang, Tainan Hsien (TW)

Correspondence Address: BACON & THOMAS, PLLC, 625 SLATERS LANE, FOURTH FLOOR, ALEXANDRIA, VA, 22314

(73) Assignee: KUAN HSINGS ENTERPRISE CORP., Tainan Shien (TW)

(21) Appl. No.: 10/383,518

(22) Filed: Mar. 10, 2003

(30) Foreign Application Priority Data
Jan. 23, 2003 (TW) 92201651

(51) Int. Cl. B60R 3/00

(52) U.S. Cl. 280/163

(57) ABSTRACT

The present invention comprises a footrest with a poking rod; a bumper with an embedding hole is formed on the footrest; a latch member having two bent latch plates, each latch plate having a latch groove with a corresponding concave neck disposed inwardly, and a corresponding concave latch fork inwardly disposed, a latch wing outwardly disposed is formed on the latch groove; a corresponding outwardly protruded extension section is defined under the latch groove; such that the poking rod is clipped by the two plates of the latch member, and engaged by the latch fork. The footrest with the latch member and the poking rod are fully embedded and inserted into the embedding hole on the base of the bumper and secured into a fixed position.

### BACKGROUND OF THE INVENTION

1. Field of the Invention

This invention relates to an automobile footrest latch structure and its latch thereof, more particularly to a latch structure that makes use of a latch member to force its embedment into the bumper of an automobile.

2. Description of the Related Art

In general, an automobile has a bumper in the front and at the back of the automobile. A sedan usually has an elegant style and makes the bumper as an integral plastic part of the car, and the bumpers of motor vehicles with loading or leisure features (such as the station wagon, van, and jeep) are usually made of stainless steel tube. Taking the bumper 1 as shown in FIG. 1 for example, it generally comprises a fixed rod 11 and a tubular body 12; the fixed rod 11 is used to install the bumper to the car (generally a predetermined fixed position under the chassis) and a footrest 13 is generally installed at the upper section of the tubular body 12. Please refer to FIG. 2. A general footrest 13 forms a stepping section 131, and a curved section 132 slightly in the arc shape on both sides, and a cylindrical poking rod 133 is disposed under the footrest 13 to correspond to the embedment into an embedding hole 122 on a base 121 of the tubular body 12 in order to secure the footrest into a fixed position.

However, the automobile installing this kind of bumper usually has a requirement of driving in a poor road conditions, such as a jeep. Even not in the situation of a poor road condition, it also has lots of bumping during loading and unloading such as in a truck. Footrest is used for stepping, a long-time use will deform the footrest or cause the poking rod 133 of the footrest to be loosened from the embedding hole 122, so that the footrest 13 will fall off. It is very impractical.

### SUMMARY OF THE INVENTION

The objective of this invention is to provide an improved automobile footrest structure and its latch member, which comprises a footrest with a poking rod; a bumper having an embedding hole; a latch member having two bent latch plates, each latch plate having a latch groove with a corresponding inwardly concave neck, and a corresponding latch fork disposed inward; the upper section of the latch groove defines a corresponding outward latch wing, and the lower section of the latch groove defines a corresponding protruded extension section; the two latch plates clip the poking rod, and then the footrest together with the poking rod and latch member are inserted into the embedding hole of the base of the bumper to secure the footrest into a fixed position.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

Other features and advantages of the present invention will become apparent in the following detailed description of the preferred embodiments with reference to the accompanying drawings, in which:

FIG. 1 is an illustrative diagram of a prior art bumper of a motor vehicle.

FIG. 2 is a cross-sectional diagram of a prior art footrest structure of a motor vehicle.

FIG. 3 is an illustrative diagram of a latch member of a preferred embodiment of the present invention.

FIG. 4 is a cross-sectional diagram of a footrest being embedded into a latch member in accordance with a preferred embodiment of the present invention.

FIG.5 is a cross-sectional diagram of the cross-section A-A of a preferred embodiment of the present invention.

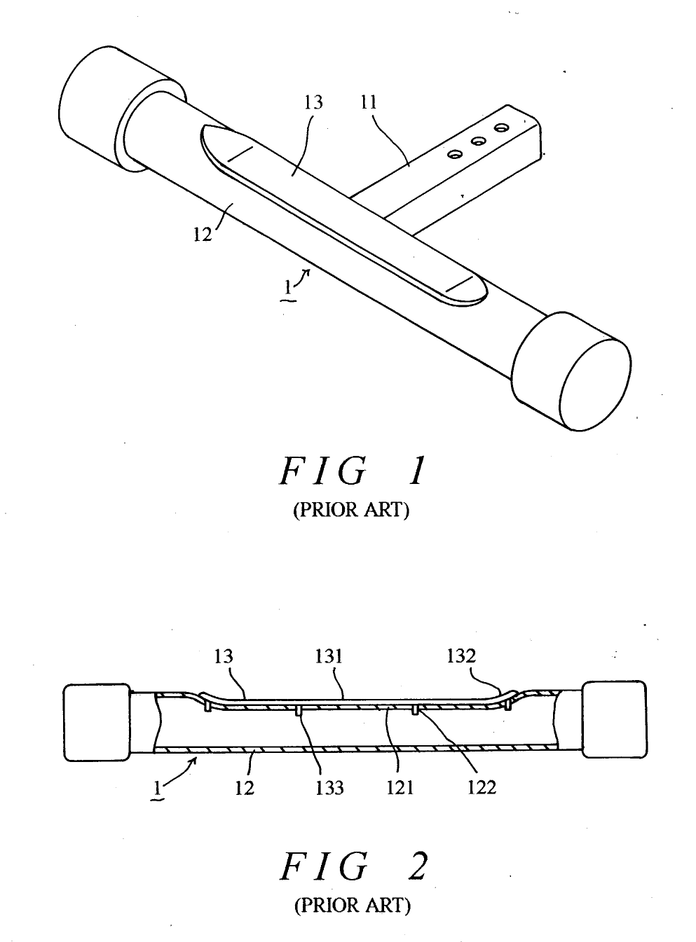

### DETAILED DESCRIPTION OF THE PREFERRED EMBODIMENTS

In the detailed description of the preferred embodiments, it should be noted that like elements are indicated by the same reference numerals throughout the disclosure.

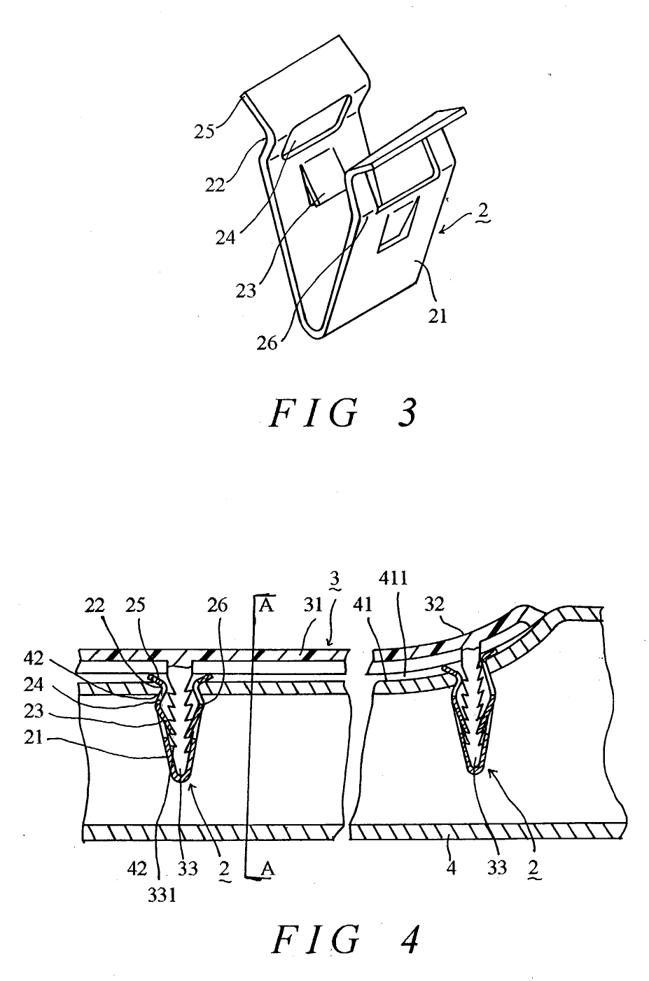

Referring to FIG. 3, the preferred embodiments of the present invention comprise a latch member 2 having two latch plates 21 bent into an appropriate angle, each latch plate 21 having a latch groove 22 with a corresponding concave neck disposed inwardly, and a corresponding concave latch fork 23 inwardly disposed, and each latch plate 21 has an escape hole 24 proximate the latch groove 22 for reducing the weight of the latch member 2 and prevent the tumbling when the latch plate is embedded; a corresponding outwardly latch ring 25 is defined above the groove 22 defined by two latch plates to form the neck, and a corresponding outwardly protruded extension section 26 is defined under the latch groove 22. The outer width between two latch wings and two extension sections 26 is larger than the inner width between two latch grooves defined by two latch plates 21 to form the neck.

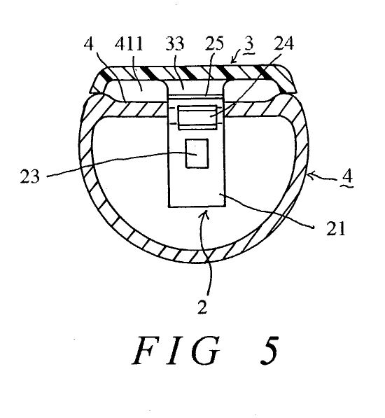

Referring to FIGS. 3 and 5, a footrest 3 comprises a level stepping section 31, and a curve section 32 slightly in an arc shape on both sides, a poking bar in the shape of a long bar with a rectangular cross section is disposed under the footrest 3, and the width ofthe poking bar 33 is about the same as the width of the latch member 2 and the latch plate 21, and a plurality of parallel ratcheted serrations 331 are formed on the surface on both sides; a concave base 41 is defined on a bumper 4, and a rectangular embedding hole 42 corresponding to the poking rod 33 ofthe footrest 3 is disposed on the bumper 4, and the poking rod 33 is clipped by two latch plates 21 under the poking rod 33 from the latch member 2 before the footrest 3 is embedded into the bumper 4. By that time, each latch fork 23 on the latch plate 21 is exactly embedded into the ratcheted serrations 331 of the poking rod 33, and the footrest 3 is inserted into an embedding hole 42 of the base 41 of the bumper 4 by overcoming the compressed elasticity on the extension section 26 by the poking rod 33 with the latch member 2. Then the two latch grooves 22 are exactly embedded into the embedding hole 42, and the latch wing 25 are above the embedding hole 42 and exactly accommodated in the escape groove 411 concavely disposed on the base 41. The extension section 26 is under the embedding hole 42 of the extension section 26, and the width of the latch wing 25 and the extension section 26 is larger than the width of the embedding hole 42 so that the latch member 2 and the poking rod 33 integrally latched together are fully embedded into the embedding hole 42 and secured into a fixed position.

Referring to FIG. 4, the poking rod 33 located at the curved section 32 of the footrest 3 can clip a latch member 2 having latch plates 21 of different lengths primarily used for fitting the various height of the curved shape of the base 21 on the bumper 4. Two latch plates 21 form various height to fit different heights, and can prevent the unstable situation of only embedding the latch groove 22 into the embedding hole 42 by one latch plate 21.

The embodiment of the present invention uses a latch fork 23 of the latch member 2 to embed the ratchet serration 331 of the poking rod 33. When an external force is exerted on the footrest 3 which will be shifted upward, the poking rod 33 shifts the ratchet serration 331 upward and exerts a force on the latch fork 23, which will expand the extension section 26 of the latch member 2 to a greater extent, and be stuck under the embedding hole 42, so that the latch member 2 is unable to move out from the embedding hole 42, and thus further enabling the latch member 2 to clip the poking rod 33 so that the poking rod 33 cannot be moved out from the embedding hole 42, and the footrest 3 can then be mounted and secured on the base 41 of the bumper 4.

While the present invention has been described in connection with what is considered the most practical and preferred embodiment, it is understood that the invention is not limited to the disclosed embodiments but is intended to cover various arrangements included within the spirit and scope of the broadest interpretation and equivalent arrangements.

What is claimed is:

1. An automobile footrest latch structure, comprising of:
a footrest, having a stepping section disposed on said footrest, and a poking rod under said footrest;
a bumper, having a base disposed on said bumper, and an embedding hole corresponsive to the poking rod of said footrest disposed on said base;
a latch member, having two latch plates bent to an appropriate angle, each latch plate having a latch groove with a corresponding inwardly concave neck, a corresponding latch fork disposed inward, a corresponding latch wing disposed outward and above the latch groove defined by the corresponding neck of the two latch plates, and a corresponding outwardly protruded extension section defined under the latch groove; thereby said two latch plates clipping the poking rod and said latch fork engaging the poking rod, and the footrest embedding and inserting the poking rod with the latch member into the embedding hole on the base of the bumper to secure the footrest into a fixed position.

2. An automobile footrest latch structure as claimed in claim 1, wherein said poking rod has a width substantially equal to the width of the latch member and the latch plate.

3. An automobile footrest latch structure as claimed in claim 1, wherein said poking rod is a rectangular bar with a rectangular cross section.

4. An automobile footrest latch structure as claimed in claim 1, wherein said poking rod forms a plurality of ratchet serrations on the surface of both sides of said poking rod.

5. An automobile footrest latch structure as claimed in claim 1, wherein said footrest forms a curved section on both sides of said footrest.

6. An automobile footrest latch structure as claimed in claim 5, wherein said latch member embedded into the curved section of the footrest where the poking rod is embedded has a latch plate of a different length.

7. An automobile footrest latch structure as claimed in claim 1, wherein said latch wing is above the embedding hole and exactly accommodated into an escape groove concavely disposed on the base.

8. An automobile footrest latch structure as claimed in claim 1, wherein said latch plate of the latch member has an escape hole proximate the latch groove.

9. A latch member, comprising two latch plates bent to an appropriate angle, each latch plate having a latch groove with a corresponding concavely formed neck, and a corresponding outwardly protruded extension section being formed under the latch groove, and the width between two latch wings and two extension sections being larger than inner side of the two latch grooves defined by the necks of two latch plates.

10. A latch member as claimed in claim 9, wherein said latch plate proximate the latch groove has an escape hole.

11. A latch member as claimed in claim 9, wherein said two latch plates are different in length.
